(19) United States
(12) Patent Application Publication
(10) Pub. No.: US 2007/0024054 A1
(43) Pub. Date: Feb. 1, 2007

(54) Tube connection structure

(75) Inventor: Shi Chia Ko, Changhua Hsien (TW)

Correspondence Address: TROXELL LAW OFFICE PLLC, SUITE 1404, 5205 LEESBURG PIKE, FALLS CHURCH, VA, 22041, US

(73) Assignee: Chung Cheng Faucet Co., Ltd.

(21) Appl. No.: 11/189,778

(22) Filed: Jul. 27, 2005

(51) Int. Cl. F16L 19/00

(52) U.S. Cl. 285/354; 285/903

(57) ABSTRACT

A tube connection structure comprises a connector, a tubular sleeve, a coupling tube, and a washer wherein the connector has an internal screw-threaded section, and the tubular sleeve has a connecting hole and a connecting section defined by a flat-type abutment face disposed at one end. The coupling tube is provided with a multi-layered engagement portion having flat abutting faces disposed at both side surfaces thereon to be respectively connected with the abutment face of the tubular sleeve and a flat abutted surface of the washer thereby. Therefore, the coupling tube can be closely engaged with the tubular sleeve and the washer, and formed a flat-type connecting joint therewith to provided a reinforced and securely tight tube connection structure thereby (especially when to seal off the water discharge under high pressure), efficiently avoiding any gaps or leaking produced therein to achieve better water-sealing and anti-leakage effect thereby.

### BACKGROUND OF THE INVENTION

The present invention is related to a tube connection structure, comprising a connector, a tubular sleeve, a coupling tube, and a washer wherein the coupling tube is provided with a multi-layered engagement portion having flat abutting faces disposed at both side surfaces thereon to be respectively connected with an abutment face of the tubular sleeve and a flat abutted surface of the washer thereby. Therefore, the coupling tube can be closely engaged with the tubular sleeve and the washer, and form a flat-type connecting joint therewith to provide a reinforced and securely tight tube connection structure thereby (especially when to seal off the water discharge under high pressure), efficiently avoiding any gaps and leaking produced therein to achieve better water-sealing and anti-leakage effect thereby.

Please refer to FIGS. 1 to 2 inclusive. A conventional tube connection structure includes a coupling tube 10 equipped with an arcuate portion 11 bent at the upper end thereof, a connector 20 with internal screw-threaded section 21 to be mounted to the coupling tube 10 thereof, and a tubular sleeve 30 with an oblique joining face 31 defining one end surface thereon accommodated at the coupling tube 10 therein, permitting a lower engaging face 32 disposed at the other side thereof to abut against the arcuate portion 11 of the coupling tube 10 thereof. A washer 40 having a set of upper and lower slant slopes 41, 42 disposed at both sides thereon is provided to accommodate to the interior of the connector 20, permitting the lower slant slope 42 to abut against the oblique joining face 31 of the tubular sleeve 30 thereon. A pipe 50 having an external screw-threaded section 51 defining thereon is mounted into the connector 20 with the internal screw-threaded section 21 securely locked to the external screw-threaded section 51 thereof.

There are some drawbacks to such conventional tube connection structure. First, the arcuate portion 11 of the coupling tube 10 is directly bent into a curvature and sequentially abutted against by the tubular sleeve 30 and the washer 40 mounted at the upper side thereon. In assembly, the external screw-threaded section 51 of the pipe 50 is secured tight into the internal screw-threaded section 21 of the connector 20, which can generate a down pressing force affecting the coupling tube 10 and cause the arcuate portion 11 there f to get deformed and damaged thereby. Second, the upper and lower slant slopes 41, 42 of the washer 40 are respectively tilted into an angle and can only partially and unevenly abut against the lower end edge of the pipe 50 and the oblique joining face 31 of the tubular sleeve 30, which, due to the smaller conjoining contact area thereof, tends to produce a number of gaps A therein and fails to efficiently seal off the water discharge and avoid the leakage of water thereof. Thus, the pipe 50 must be screwed up really hard to press tight against the slant slopes 41, 42 of the washer 10 so as to deform it to provide a flat-type abutment effect thereby, which is not only time-consuming and painfully troublesome, but can easily wear off and damage the washer 40 thereby.

### SUMMARY OF THE PRESENT INVENTION

It is, therefore, the primary purpose of the present invention to provide a tube connection structure, comprising a connector, a tubular sleeve, a coupling tube, and a washer wherein the coupling tube is provided with an engagement portion having a flat abutting face defining both side surfaces thereon to be respectively connected with an abutment face of the tubular sleeve and a plane abutted surface of the washer to provide a flat-type connecting joint and a reinforced and securely tight tube connection structure thereby (especially when to seal off the water discharge under high pressure), efficiently avoiding any gaps and leaking produced therein to achieve better water-sealing and anti-leakage effect thereby.

It is, therefore, the second purpose of the present invention to provide a tube connection structure wherein the engagement portion of the coupling tube is made in multi-layer with the flat abutting faces disposed at both sides to connect with the tubular sleeve and the washer respectively. Thus, when a pipe is tightly secured to the connector thereof with a down pressing and squeezing force generated therewith, the tubular sleeve mounted at the lower section of the engagement portion thereof can offer an appropriate buffering support so that the engagement portion thereof won't get twisted and deformed in application, ensuring a complete tight and sealed-off tube connection structure in case of high/lower water pressure to achieve the best assembly benefit thereof.

### BRIEF DESCRIPTION OF THE DRAWINGS

FIG. 1 is an exploded perspective view of a conventional tube connection structure.

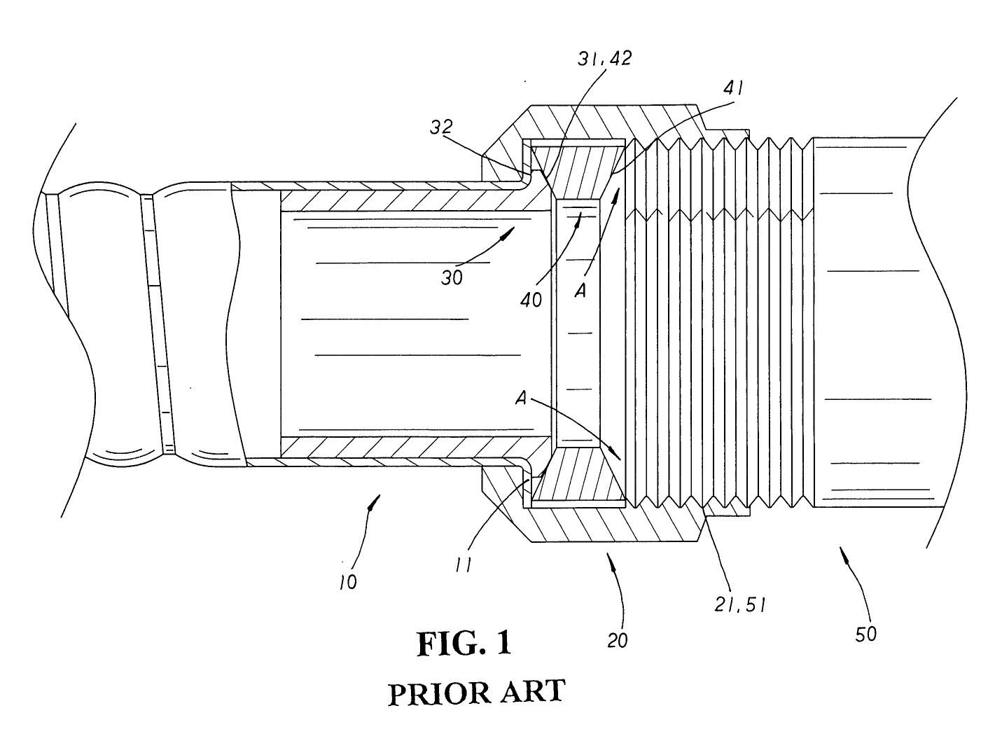

FIG. 2 is an assembled cross sectional view of the conventional tube connection structure.

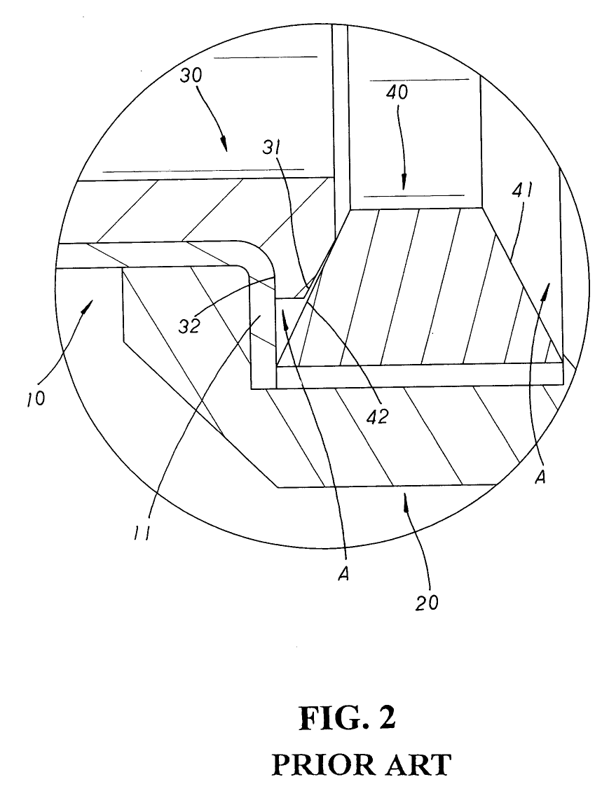

FIG. 3 is an exploded perspective view of the present invention.

FIG. 4 is an assembled cross sectional view of the present invention.

FIG. 5 is an exploded perspective view of another embodiment of the present invention.

FIG. 6 is an assembled cross sectional view of another embodiment of the present invention.

### DETAILED DESCRIPTION OF THE PREFERRED EMBODIMENTS

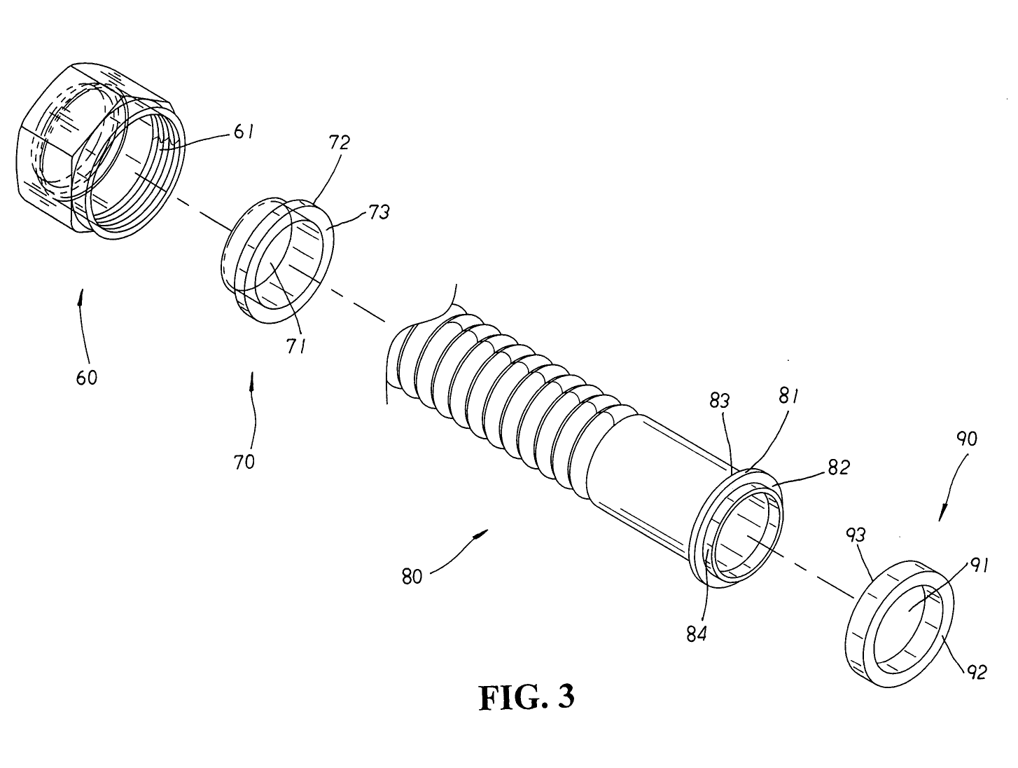

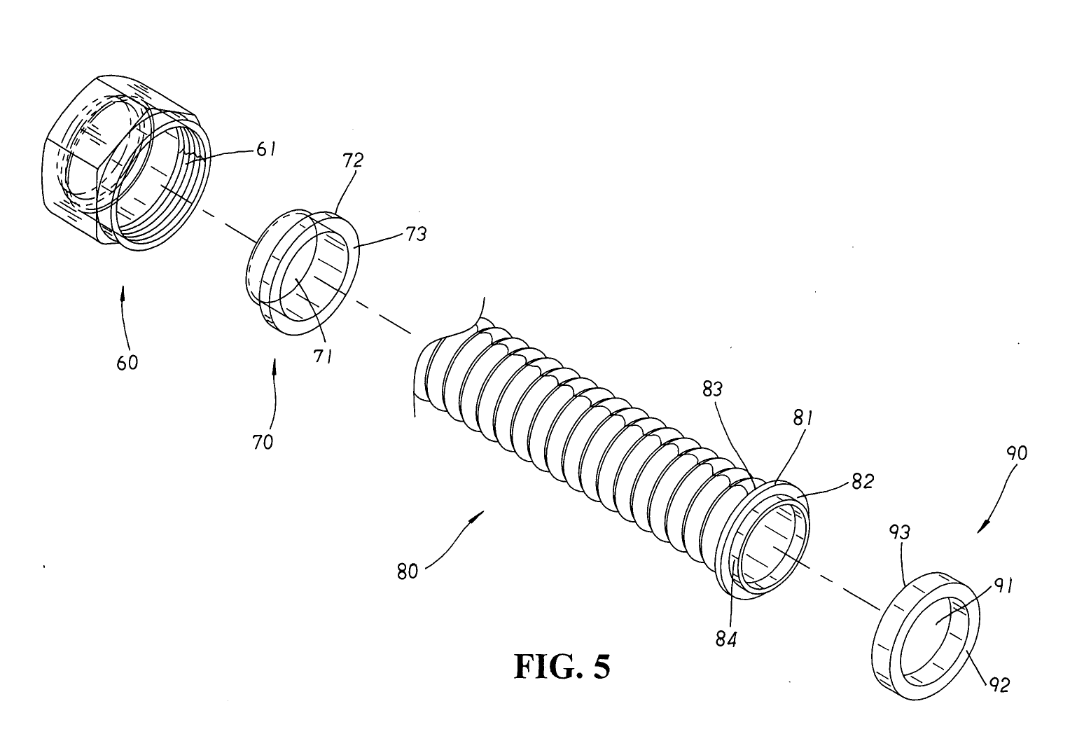

Please refer to FIG. 3 showing an exploded perspective view of the present invention. The present invention is related to a tube connection structure, including a connector 60, a tubular sleeve 70, a coupling tube 80, and a washer 90. The connector 60 is equipped with an internal screw-threaded section 61, and the tubular sleeve 70 has a connecting hole 71, and a connecting section 72 defined by a flat-type abutment face 73 protruding at one end thereof. The coupling tube 80 is equipped with an integrally press-molded and multi-layered engagement portion 81 having a set of flat-type upper and lower abutting faces 82, 83 defining both side surfaces thereon to be respectively jointed to the washer 90 and the tubular sleeve 70 thereby. The upper abutting face 82 of the engagement portion 81 thereof has an engaging end 84 extending at the upper section thereon, and the lower abutting face 83 has a smooth-surface section as shown in FIG. 3, or a spirally-threaded section as shown in FIG. 5 extending at one adjacent side thereon. The washer 90 is equipped with a central hole 91 reciprocally matched with the engaging end 84 of the coupling tube 80 thereof, and a set of flat-type pressed surface 92 and an abutted surface 93 defining both side edges thereon.

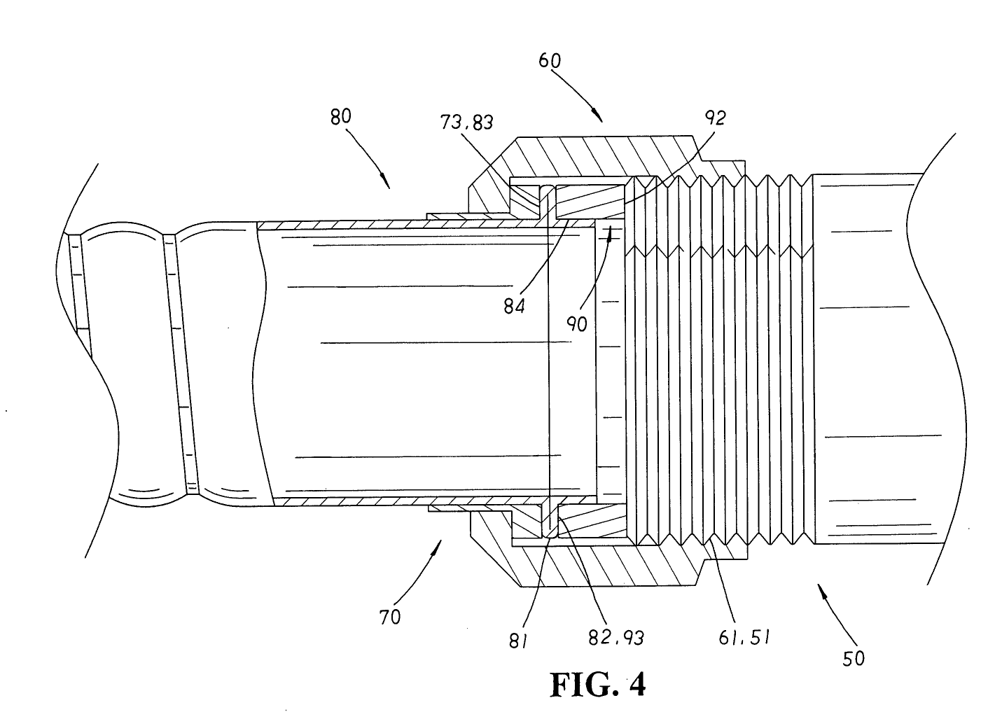

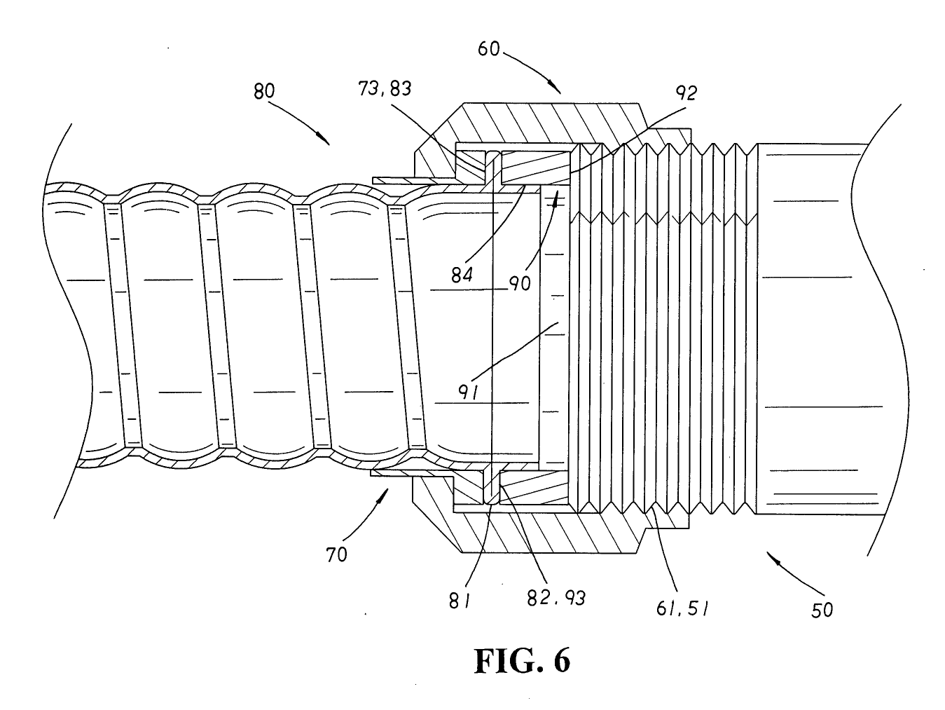

Please refer to FIGS. 4, 6. In assembly, the connecting hole 71 of the tubular sleeve 70 is guided through the coupling tube 80, permitting the abutment face 73 thereof to flatly contact with the lower abutting face 83 defining one side of the engagement portion 81 of the coupling tube 80 thereof. Then, the coupling tube 80 is engaged with the connector 60 at an appropriate position, and the central hole 91 of the washer 90 is jointed to the engagement portion 81 of the coupling tube 80, permitting the inner circumferential surface thereof to tightly abut against the engaging end 84 of the coupling tube 80 thereby. Meanwhile, the abutted surface 93 defining the lower side surface of the washer 90 is flatly contacted with the upper abutting face 82 of the coupling tube 80 thereof. Finally, an external screw-threaded end 51 of a pipe 50 is securely locked to the internal screw-threaded section 61 of the connector 60, permitting the bottom end edge of the external screw-threaded section 51 thereof to abut tight against the pressed surface 92 of the washer 90 to complete the assembly of the present invention.

Therefore, via the flat-type upper and lower abutting faces 82, 83 defining both sides of the engagement portion 81 of the coupling tube 80, the abutment face 73 of the tubular sleeve 70 and the abutted surface 93 of the washer 90 can be closely joined with both sides of the engagement portion 81 respectively and form a flat-type connecting joint therewith to provide a reinforced and securely tight tube connection structure thereby (especially when to seal off the water discharge under high water pressure). Besides, the lower end of the pipe 50 can also be flatly abutted against the pressed surface 92 of the washer 90 to avoid any spaces or gaps produced there-between that can cause the problems of water leakage or infiltration thereof. Meanwhile, when the pipe 50 is locked tight to the connector 60 with a down pressing or squeezing force generated therewith, the engagement portion 81 of the coupling tube 80 integrally molded in multiple layers and the tubular sleeve 70 mounted at the lower section thereof can offer appropriate buffering support to resist the pressure thereof so that the engagement portion 81 can refrain from getting twisted or deformed in application, efficiently achieving better water-sealing and anti-leakage effect and ensuring a completely tight tube connection structure in case of high/lower water pressure for the best assembly benefit thereof.

1-3. (canceled)

4. A tube connection structure to be connected with a pipe, the tube connection structure comprising:
a) a connector having internal threads connected to external threads of the pipe;
b) a tubular sleeve located in the connector and having:
I) a connecting hole; and
ii) a connecting section having a flat abutment face;
c) a coupling tube inserted through the connecting hole of the tubular sleeve and having an engagement portion and an engaging end protruding outwardly from the engagement portion; and
d) a washer having a central hole, the engaging end of the coupling tube is inserted into the central hole,
wherein the connecting section, the engagement portion, and the washer are pressed between the first end of the tube and the connector.

5. The tube connection structure according to claim 4, wherein the engagement portion has a coupling tube first flat face and a coupling tube second flat face, the washer has a washer first flat face and a washer second flat face, the connector engaging the flat abutment face, the flat abutment face engaging the coupling tube first flat face, the coupling tube second flat face engaging the washer first flat face, and the coupling tube second flat face engaging the first end of the tube.

6. The tube connection structure according to claim 4, wherein the coupling tube has an exterior section located adjacent to the engagement portion on a side opposite the engaging end, the exterior section has a smooth surface.

7. The tube connection structure according to claim 4, wherein the coupling tube has an exterior section located adjacent to the engagement portion on a side opposite the engaging end, the exterior section has a threaded surface.
